(19) United States
(12) Patent Application Publication
(10) Pub. No.: US 2017/0054197 A1
(43) Pub. Date: Feb. 23, 2017

(54) ANTENNA DEVICE AND COMMUNICATION MODULE

(71) Applicant: FUJITSU LIMITED, Kawasaki-shi (JP)

(72) Inventor: Shohei ISHIKAWA, Yokohama (JP)

(21) Appl. No.: 15/232,536

(22) Filed: Aug. 9, 2016

(30) Foreign Application Priority Data
Aug. 21, 2015 (JP) 2015-163832

(51) Int. Cl. H01Q 1/24; H01Q 1/48; H01Q 9/04; H01Q 1/36

(52) U.S. Cl. CPC H01Q 1/243; H01Q 1/36; H01Q 1/48; H01Q 9/0407

(57) ABSTRACT

An antenna device includes a first dielectric having a plate-like shape that has a first surface and a second surface, the first surface opposing the second surface; a second dielectric having a plate-like shape, the second dielectric rising from the second surface, the second dielectric forming a T-shaped configuration with the first dielectric, the second dielectric having a distal end opposing the second surface; and an antenna arranged on the distal end, the antenna being configured to radiate a millimeter wave having an electric field changing in a thickness direction of the second dielectric, wherein wireless communication is performed through the first surface.

### CROSS-REFERENCE TO RELATED APPLICATION

This application is based upon and claims the benefit of priority of the prior Japanese Patent Application No. 2015-163832, filed on Aug. 21, 2015, the entire contents of which are incorporated herein by reference.

### FIELD

The embodiments discussed herein are related to an antenna device and a communication module.

### BACKGROUND

To date, an electronic apparatus including a housing having a first surface and an induced electric field antenna has been provided. The induced electric field antenna is disposed in the housing and includes a coupling electrode disposed opposite to a first area in the first surface. The electronic apparatus further includes a millimeter wave antenna which is disposed in the housing on the opposite side of the first area with respect to the induced electric field antenna and includes a plurality of millimeter wave antenna elements which are disposed at an outer side than the outer edge of the bottom of the induced electric field antenna such that a neighboring space of the first area is included in a cover area of the millimeter wave antenna. The electronic apparatus further includes a proximity wireless communication unit which is disposed in the housing, and transmits and receives a radio signal having a first frequency band through the induced electric field antenna, and transmits and receives a radio signal having a higher millimeter wave band than the first frequency band through the millimeter wave antenna. For example, refer to Japanese Laid-open Patent Publication No. 2012-090228.

### SUMMARY

According to an aspect of the invention, an antenna device includes a first dielectric having a plate-like shape that has a first surface and a second surface, the first surface opposing the second surface; a second dielectric having a plate-like shape, the second dielectric rising from the second surface, the second dielectric forming a T-shaped configuration with the first dielectric, the second dielectric having a distal end opposing the second surface; and an antenna arranged on the distal end, the antenna radiating a millimeter wave having an electric field changing in a thickness direction of the second dielectric, wherein wireless communication is performed through the first surface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an electronic apparatus including an antenna device;

FIG. 2 is a perspective view illustrating the antenna device;

FIG. 3 is a cross-sectional view taken along line A1-A2 of FIG. 2;

FIG. 4 is a cross-sectional view taken along line B1-B2 of FIG. 2;

FIG. 5 is a plan view illustrating an antenna included in the antenna device;

FIG. 6 is a diagram illustrating a direction of an electric field of a millimeter wave that leaks outside a plate;

FIG. 7 is a diagram illustrating a direction of an electric field of a millimeter wave that leaks outside a plate;

FIG. 8 is a diagram illustrating distribution of the S21 parameter of the antenna device;

FIG. 9 is a diagram illustrating distribution of the S21 parameter by a comparative antenna device;

FIG. 10 is a diagram illustrating distribution of the S21 parameter by a comparative antenna device;

FIGS. 11A, 11B, and 11C are diagrams illustrating a dipole antenna, a slot antenna and a loop antenna, respectively;

FIG. 12 is a cross-sectional view illustrating an antenna device according to a first variation of a first embodiment;

FIG. 13 is a cross-sectional view illustrating an antenna device according to a second variation of the first embodiment;

FIG. 14 is a cross-sectional view illustrating an antenna device according to a third variation of the first embodiment; and

FIG. 15 is a cross-sectional view illustrating a communication module including an antenna device according to a fourth variation of the first embodiment.

### DESCRIPTION OF EMBODIMENTS

A millimeter wave antenna in the related-art electronic apparatus includes a plurality of millimeter wave antenna elements. This is because the millimeter wave antenna elements have high straightness and narrow communication possible areas, and thus this is for the purpose of expanding a communication possible area.

However, when a plurality of millimeter wave antenna elements are used, power consumption becomes high.

Accordingly, there is a problem in that the millimeter wave antenna in the related-art electronic apparatus has high power consumption.

Thus it is desirable to provide an antenna device and a communication module that have a secure communication possible area with reduced power consumption.

In the following, a description will be given of embodiments to which an antenna device and a communication module according to the present disclosure is applied.

### Embodiments

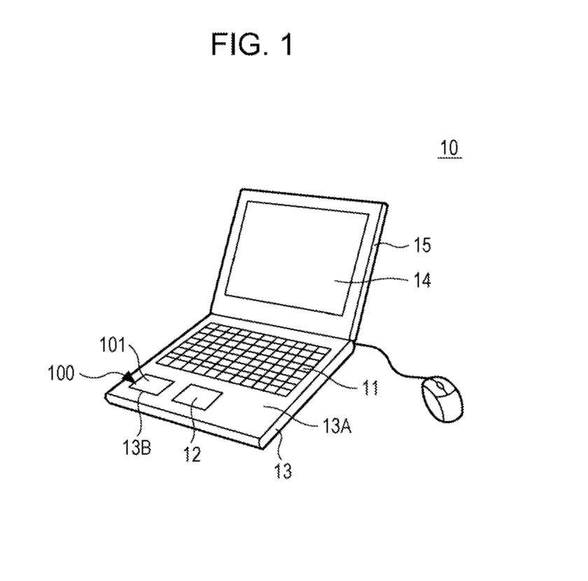

FIG. 1 is a diagram illustrating an electronic apparatus 10 including an antenna device 100. The electronic apparatus 10 is a notebook-sized personal computer (PC).

The electronic apparatus 10 includes a keyboard 11, a touch pad 12, a housing 13, a display panel 14, a housing 15, and the antenna device 100.

The keyboard 11, the touch pad 12, and the antenna device 100 are disposed on the housing 13. The antenna device 100 is disposed on the side of the touch pad 12 on the housing 13. The display panel 14 is disposed on the housing 15.

The antenna device 100 is a communication device that performs near field wireless communication using a millimeter wave. The antenna device 100 is disposed on the housing 13 such that a radiation surface 101 is exposed from an opening 13B of a surface 13A of the housing 13, and radiates a millimeter wave from the radiation surface 101. The parts other than the radiation surface 101 of the antenna device 100 are contained inside the housing 13, and thus the parts are not viewed from the outside of the electronic apparatus 10.

Here, a description will be given of a configuration in which the antenna device 100 transfers data with a smartphone terminal, on which an antenna device capable of communicating with the antenna device 100 is mounted, by near field wireless communication as an example.

In this regard, a near field mentioned here represents a distance within a few millimeters from the surface 13A as an example, and the smartphone terminal may contact the surface 13A. Also, near field wireless communication may be referred to as proximity wireless communication.

Also, in the following, a description will be given of a configuration in which the antenna device 100 radiates a millimeter wave from the radiation surface 101. However, it is possible for the antenna device 100 to receive a millimeter wave from another communication device disposed in the vicinity of the radiation surface 101.

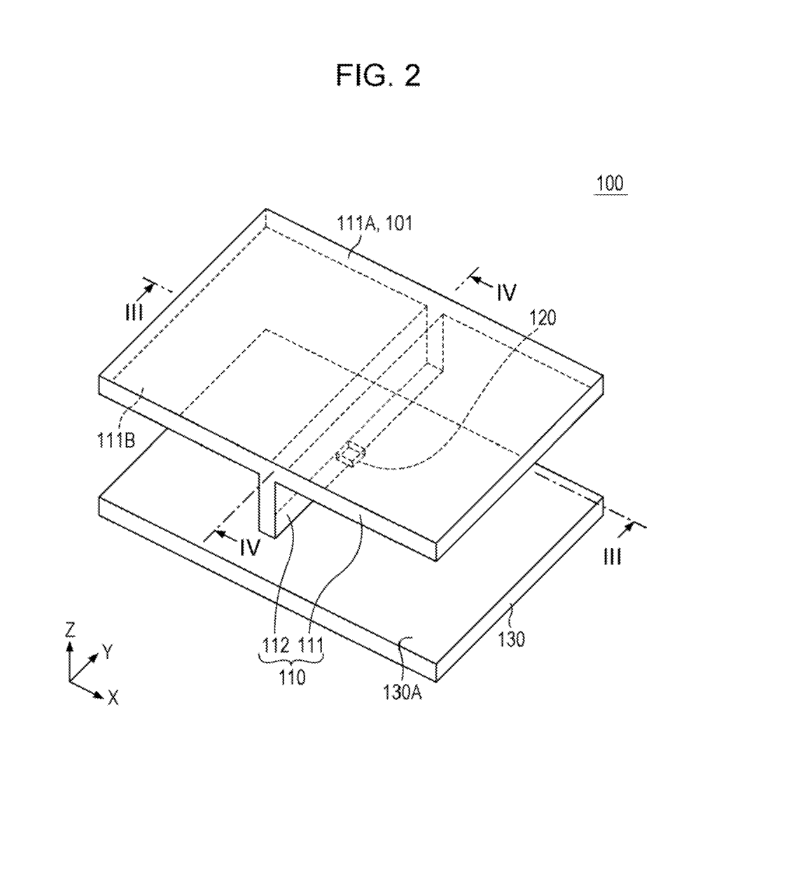

Next, a description will be given of the antenna device 100 with reference to FIGS. 2 to 5.

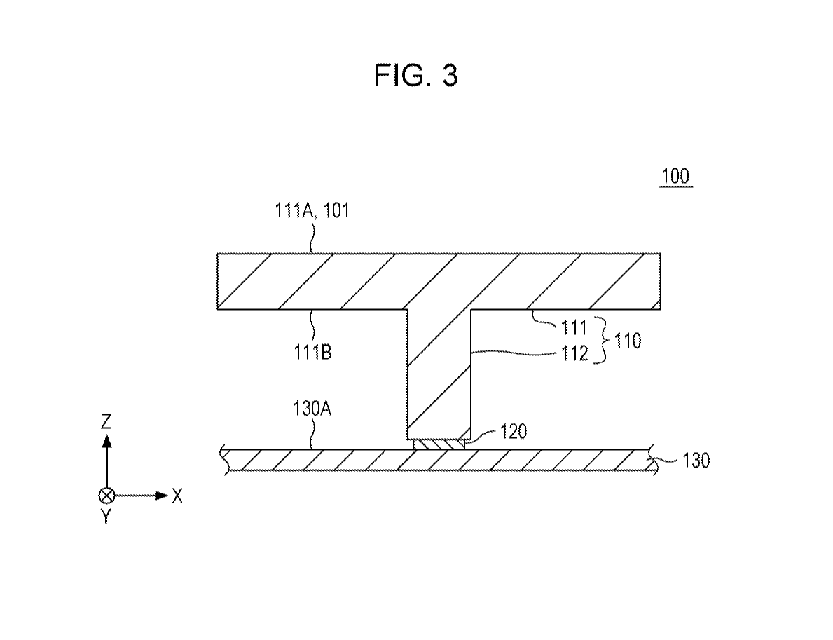

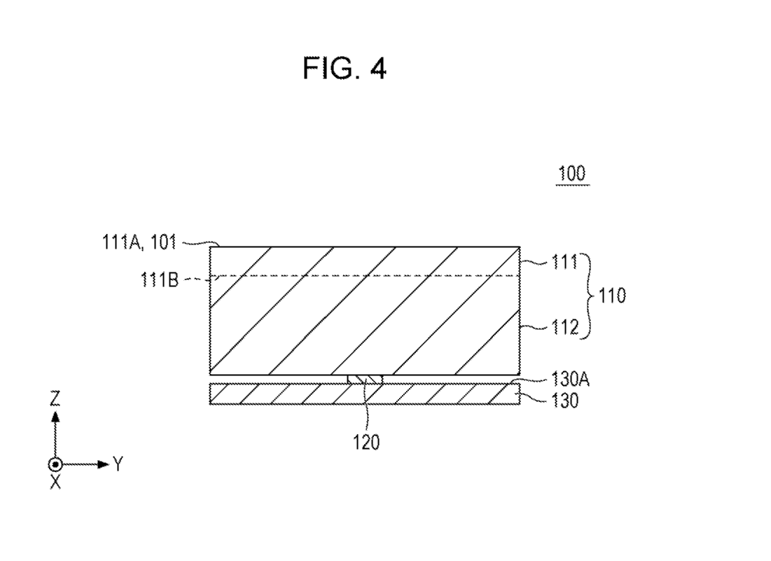

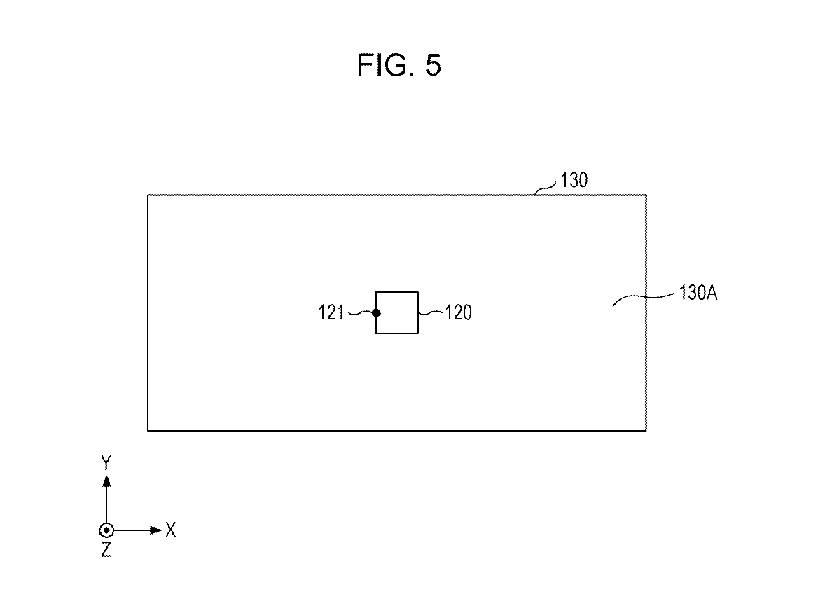

FIG. 2 is a perspective view illustrating the antenna device 100. FIG. 3 is a cross-sectional view taken along line III-III of FIG. 2. FIG. 4 is a cross-sectional view taken along line IV-IV of FIG. 2. FIG. 5 is a plan view illustrating an antenna 120 included in the antenna device 100. In this regard, in the following, a description will be given using an XYZ coordinate system, which is an orthogonal coordinate system.

The antenna device 100 includes a radiation plate 110, an antenna 120, and a substrate 130.

The radiation plate 110 includes plates 111 and 112, and has a T-shaped configuration as viewed from the Y-axis direction.

The plate 111 is a plate-like member parallel to an XY plane, and is made of a dielectric material. The plate 111 is an example of a first dielectric. The thickness of the plate 111 is preferably as thick as having a small loss when the plate 111 functions as a waveguide. The thickness of the plate 111 is 2 mm as an example.

A surface 111A of the plate 111 on the positive direction side of the Z-axis is a radiation surface from which the antenna device 100 radiates a millimeter wave, and is the radiation surface 101 illustrated in FIG. 1.

An end part of the plate 112 on the positive direction side of the Z-axis is connected to a surface 111B of the plate 111 on the negative direction side. In other words, the plate 112 vertically protrudes from the surface 111B of the plate 111 in the negative direction of the Z-axis.

The plate 112 is a plate-like member parallel to the YZ plane, and is made of a dielectric material. The relative dielectric constant of the plate 112 is equal to the relative dielectric constant of the plate 111. The plate 112 is an example of a second dielectric. The plate 112 rises from the surface 111B of the plate 111 in the negative direction of the Z-axis. The thickness of the plate 112 is preferably as thick as having a small loss when the plate 112 functions as a waveguide, and may be the same as the thickness of the plate 111. The thickness of the plate 112 is 2 mm as an example.

The plate 112 protrudes from the center in the X-axis direction of the plate 111 toward the negative direction of the Z-axis side. The length of the plate 112 in the Y-axis direction is equal to the length of the plate 111 in the Y-axis direction. The end part on the negative direction of the Z-axis side of the plate 112 comes in contact with the antenna 120. The plate 112 is integrally formed with the plate 111.

The antenna 120 is disposed on the surface 130A on the positive direction side of the Z-axis of the substrate 130. The end part on the negative side of the Z-axis of the plate 112 comes in contact with the positive direction side of the Z-axis of the antenna 120.

The antenna 120 is an antenna that radiates, in the Z-axis direction, a millimeter wave having an electric field changing in the X-axis direction. Here, the antenna 120 is a patch antenna, for example. As illustrated in FIG. 5, the antenna 120 built as a patch antenna is square-shaped in an XY planar view, two sides out of the four sides of the square are parallel to the X-axis, and the remaining two sides are parallel to the Y-axis. The length of one side of the patch antenna 120 is 1.5 mm as an example.

The antenna 120 falls in the width of the X-axis direction of the plate 112 in the X-axis direction, and also falls in the width of the Y-axis direction of the plate 112 in the Y-axis direction.

A feed point 121 (refer to FIG. 5) of the antenna 120 is disposed at the center in the Y-axis direction at the end part in the negative direction side of the X-axis or at the left end of the antenna 120. The core wire of a coaxial cable, not illustrated in FIG. 5, is coupled to the feed point 121, and is supplied with a high frequency power in order to achieve a millimeter wave. The high frequency power that achieves a millimeter wave is 60 GHz, as an example.

The antenna 120 is supplied with power at the feed point 121 so as to radiate, in the Z-axis direction, a millimeter wave having an electric field that changes in the X-axis direction. The length of each of the four sides of the patch antenna used as the antenna 120 is a half of the wavelength (a half wavelength) in electrical length of the millimeter wave.

The antenna 120 is disposed on the surface 130A on the positive direction of the Z-axis side of the substrate 130. The substrate 130 is a substrate included in the housing 13 of the electronic apparatus 10 illustrated in FIG. 1, for example. The substrate 130 may be a substrate conforming to the standard for the Flame Retardant type 4 (FR4), for example. In this case, the antenna 120 may be formed by patterning a metal layer, such as a copper foil or the like disposed on the surface of the substrate 130. Also, an electronic component chip, or the like may be mounted on the substrate 130.

Also, the substrate 130 may be a part of the internal structure of the housing 13, for example, or may be a specialized member for disposing the antenna 120 thereon.

In the antenna device 100 having the above configuration, the radiation plate 110 functions as a T-shaped waveguide to guide, to the surface 111A, the millimeter wave generated and radiated by the antenna 120 in the positive direction of the Z-axis.

The millimeter wave radiated by the antenna 120 in the positive direction of the Z-axis is a linearly-polarized electromagnetic wave having an electric field changing in the X-axis direction, and the radiated millimeter wave enters the plate 112 from the end part on the negative direction side of the Z-axis of the plate 112. The antenna 120 is aligned with the end part on the negative side of the Z-axis of the plate 112 or the lower end of the plate 112 so as to fall in the X-axis direction width and the Y-axis direction width of the plate 112, and thus the millimeter wave radiated from the antenna 120 in the positive direction of the Z-axis enters the plate 112.

The electric field of the millimeter wave changes in the thickness direction (the X-axis direction) of the plate 112, and thus the millimeter wave is propagated in the positive direction of the Z-axis while being reflected in the plate 112. In this regard, a part of the millimeter wave leaks outside the plate 112.

When the millimeter wave approaches a joining part of the plate 112 and the plate 111, the plate 112 and the plate 111 function like a T-shaped waveguide, the millimeter wave is propagated inside the plate 111 in a stretching direction of the XY plane. The electric field of the millimeter wave changes in the Z-axis direction inside the plate 111.

The millimeter wave is reflected at the end parts of the plate 111 inside the plate 111. Accordingly, the millimeter wave is propagated in various directions so that the XY plane stretches inside the plate 111. Also, at this time, a part of the millimeter wave leaks outside the plate 111.

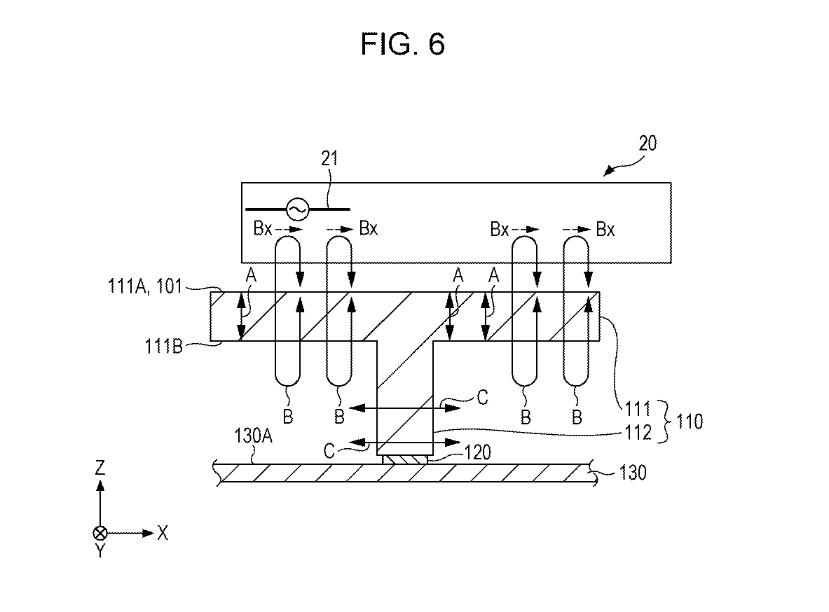

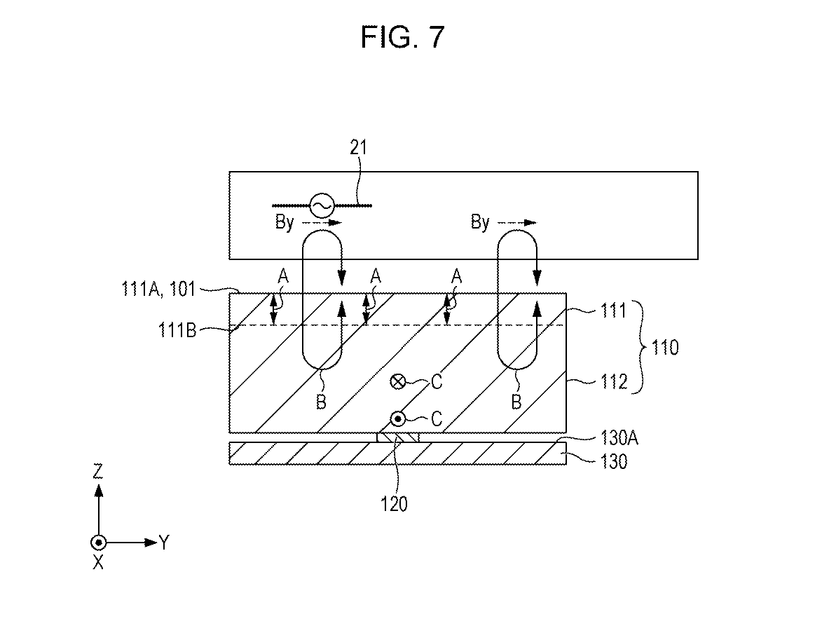

Here, a description will be given of the direction of the electric field of the millimeter wave that leaks outside the plate 111 with reference to FIG. 6 and FIG. 7.

FIG. 6 and FIG. 7 are diagrams illustrating a direction of an electric field of a millimeter wave that leaks outside the plate 111. In FIG. 6 and FIG. 7, a direction of the electric field of the millimeter wave is indicated by an arrow. FIG. 6 illustrates a cross-sectional view taken along line III-III in the same manner as FIG. 3. FIG. 7 illustrates a cross-sectional view taken along line IV-IV in the same manner as FIG. 4.

Also, in FIG. 6 and FIG. 7, a smartphone terminal 20 is illustrated. The smartphone terminal 20 includes an antenna device 21 capable of communicating with the antenna device 100.

As illustrated in FIG. 6 and FIG. 7, the electric field of the millimeter wave that is propagated inside the plate 112 changes in the Z-axis direction as illustrated by an arrow C. The electric field of the millimeter wave that is propagated inside the plate 111 changes in the Z-axis direction as illustrated by an arrow A. Also, the electric field of the millimeter wave that leaks from the plate 111 in the positive direction and the negative direction of the Z-axis is folded back at the positions within a few millimeters from the surface 111A of the plate 111 as illustrated by an arrow B.

In this manner, when the electric field is folded back, a component Bx (refer to FIG. 6) in the X-axis direction and a component By (refer to FIG. 7) in the Y-axis direction occur.

Here, only the component Bx (refer to FIG. 6) in the X-axis direction and the component By (refer to FIG. 7) in the Y-axis direction are illustrated. However, the millimeter wave is propagated in various directions in the XY plane inside the plate 111, and thus when the millimeter waves that have leaked outside the plate 111 are folded back, the components that are parallel to the XY plane in various directions occur.

In this manner, the components of the electric field that are parallel to the XY plane occur in an area within a few millimeters from the surface 111A of the plate 111.

Accordingly, it is possible to perform near field wireless communication between the antenna device 100 and the antenna device 21 which is capable of receiving the electric field components that are parallel to the XY plane, such as the components Bx and By.

In this regard, as the antenna device 21, it is possible to use various kinds of antennas, for example, a patch antenna, a dipole antenna, a monopole antenna, a slot antenna, or the like.

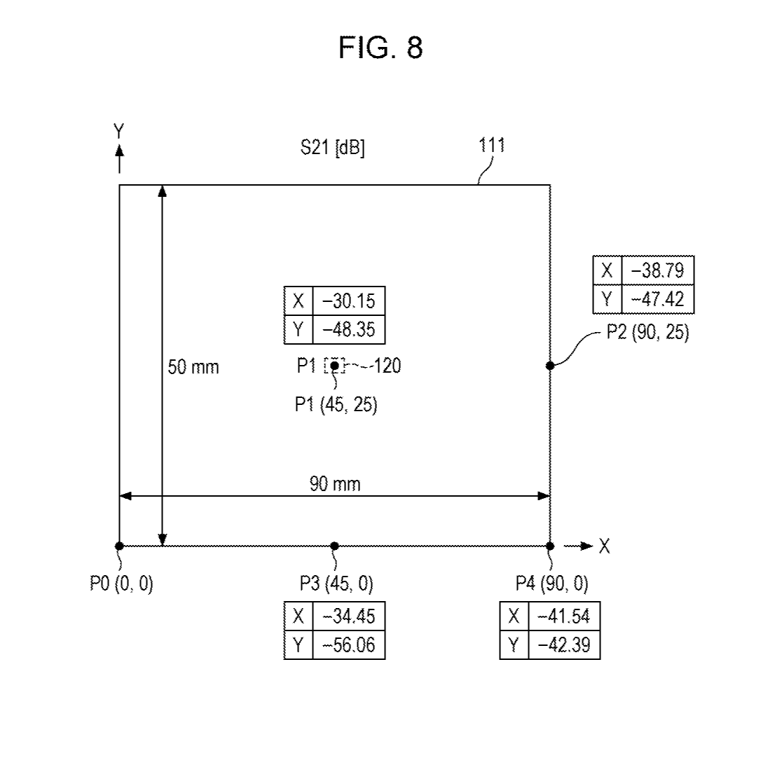

Here, a description will be given of a result of simulation with reference to FIG. 8 to FIG. 10.

FIG. 8 is a diagram illustrating distribution of the S21 parameter of the antenna device 100. FIG. 8 illustrates an XY plane view of the plate 111 and the antenna 120. The length of the plate 111 in the X-axis direction is 90 mm, and the length in the Y-axis direction is 50 mm.

The origin P0 (0, 0) of the XY coordinates were defined as illustrated in FIG. 8, and the values of the S21 parameters of the electric field in the X-axis direction and the Y-axis direction were obtained by simulation at a point P1 (45, 25), a point P2 (90, 25), a point P3 (45, 0), a point P4 (90, 0) on the surface 111A (refer to FIG. 2) of the plate 111. The simulated values of the S21 parameter in the X-axis and Y-axis directions at each point are indicated respectively X and Y as illustrated in FIG. 8.

The center of the antenna 120 is positioned just under the point P1 (45, 25).

As a result, the S21 parameter in the X-axis direction at the point P1(45, 25) was calculated as −30.15 dB, and the S21 parameter of the electric field in the Y-axis direction was calculated as −48.35 dB.

Also, the S21 parameter in the X-axis direction at the point P2(90, 25) was calculated as −38.79 dB, and the S21 parameter of the electric field in the Y-axis direction was calculated as −47.42 dB.

Also, the S21 parameter in the X-axis direction at the point P3(45, 0) was calculated as −34.45 dB, and the S21 parameter of the electric field in the Y-axis direction was calculated as −56.06 dB.

Also, the S21 parameter in the X-axis direction at the point P4(90, 0) was calculated as −41.54 dB, and the S21 parameter of the electric field in the Y-axis direction was calculated as −42.39 dB.

As described above, it is understood that a value higher than −60 dB is obtained at all the points P1 to P4. Also, in FIG. 8, the values of the S21 parameters were obtained in an area on the positive direction side of the X-axis and on the negative direction side of the Y-axis with respect to the point P0 as the center of the plate 111. This area is ¼ of the entire area of the plate 111 as the XY plane view, and from the symmetry of the plate 111, this results in obtaining a value higher than −60 dB in all the areas of the plate 111.

That is to say, it is possible for the antenna device 100 to communicate with the antenna device 21 of the smartphone terminal 20 in all the areas of the surface 111A (refer to FIG. 2) of the plate 111.

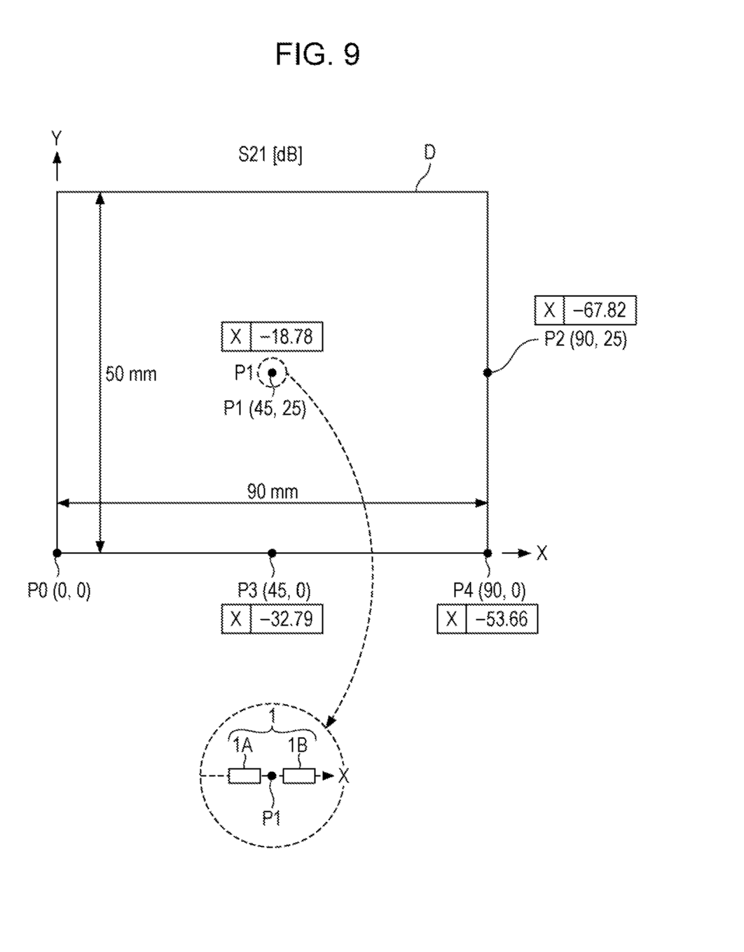

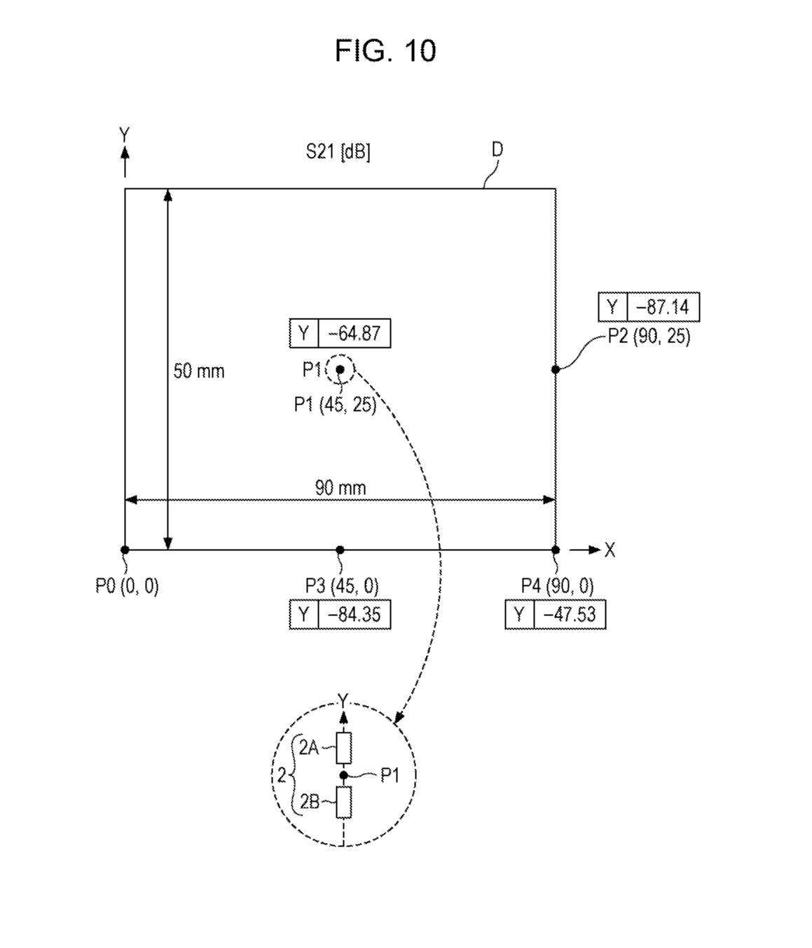

FIG. 9 and FIG. 10 are diagrams illustrating distribution of the S21 parameter by a comparative antenna device.

In FIG. 9, a dipole antenna 1 including antenna elements 1A and 1B that are disposed along the X-axis direction is disposed on the surface 130A (refer to FIG. 2) of the substrate 130 in place of the antenna 120, and the values of the S21 parameters of the electric field in the X-axis direction at the points P1 to P4 were obtained. In this regard, in FIG. 9, the radiation plate 110 is not used. The antenna elements 1A and 1B are examples of the first antenna element and the second antenna element, respectively.

In FIG. 9, the radiation plate 110 is not used, and thus the area corresponding to an area in which the radiation plate 110 in FIG. 8 is positioned is denoted by an area D.

In the same manner, in FIG. 10, a dipole antenna 2 including antenna elements 2A and 2B that are disposed along the Y-axis direction is disposed on the surface 130A (refer to FIG. 2) of the substrate 130 in place of the antenna 120, and the values of the S21 parameters of the electric field in the Y-axis direction at the points P1 to P4 were obtained. In FIG. 10, the radiation plate 110 is not used.

In FIG. 10, the radiation plate 110 is not used, and thus the area corresponding to an area in which the radiation plate 110 in FIG. 8 is positioned is denoted by an area D.

As illustrated in FIG. 9, when the dipole antenna 1 was used in place of the antenna 120 without using the radiation plate 110, the S21 parameter in the X-axis direction at a point P1(45, 25) was −18.78 dB, and the S21 parameter in the X-axis direction at a point P2(90, 25) was −67.82 dB.

Also, the S21 parameter in the X-axis direction at the point P3(45, 0) was −32.79 dB, and the S21 parameter in the X-axis direction at the point P4(90, 0) was −53.66 dB.

As just described, when the dipole antenna 1 is used, the S21 parameter values at the point P1 and the point P3 are favorable, but the S21 parameter value at the point P2 is less than −60 dB. It is therefore understood that the distribution or the range of variation of the intensity in the electric field is large in the XY plane.

When the distribution of the intensity in the electric field is large, there arises a portion in the area D in which the communication with the antenna device 21 of the smartphone terminal 20 is not established.

As illustrated in FIG. 10, when the dipole antenna 2 was used in place of the antenna 120 without using the radiation plate 110, the S21 parameter value in the Y-axis direction at the point P1(45, 25) was calculated as −64.87 dB, and the S21 parameter value in the Y-axis direction at the point P2(90, 25) was calculated as −87.14 dB.

Also, the S21 parameter value in the Y-axis direction at the point P3(45, 0) was calculated as −84.35 dB, and the S21 parameter value in the Y-axis direction at the point P4(90, 0) was calculated −47.53 dB.

Just as described, when the dipole antenna 2 is used, the S21 parameter values at the points P1 to P3 other than the point P4 are all less than −60 dB, and it is understood that the distribution or the range of variation of the intensity in the electric field is large in the XY plane.

When the distribution of the intensity in the electric field is large, a portion in the area D that is incapable of communicating with the antenna device 21 of the smartphone terminal 20 arises.

As described above, with the embodiment, it is possible to provide the antenna device 100 capable of near field communication using a millimeter wave radiated from the surface 111A of the plate 111. Also, it is possible to provide the antenna device 100 capable of receiving a millimeter wave from another communication device disposed in the vicinity of the surface 111A through the surface 111A of the plate 111.

The end part of the plate 112 is in contact with the antenna 120 using the radiation plate 110, which is formed by joining the plate 111 and the plate 112 in a T-shaped configuration, so that it is possible to guide a millimeter wave that is generated by the antenna 120 and changes the electric field in the X-axis direction in the plate 112 to the joining part between the plate 112 and the plate 111. The direction of the millimeter wave is converted by 90 degrees such that the electric field changes in the Z-axis direction at the joining part of the plate 112 and the plate 111. The Z-axis direction is the thickness direction of the plate 111.

The millimeter wave is propagated in a direction along in the XY plane inside the plate 111, and is reflected at the end faces, and thus the millimeter wave is propagated inside the plate 111 in various directions in the XY plane.

Accordingly, the electric field of the millimeter waves that leaks from the surface 111A of the plate 111 out of the plate 111 and are folded back toward the plate 111 travel toward various directions in the XY plane.

Accordingly, when the antenna device 21 in the smartphone terminal 20 is brought close to the surface 111A of the plate 111 so as to become parallel to the XY plane, it is possible for the antenna device 21 to communicate with the antenna device 100 even when the antenna device 21 faces toward any direction in the XY plane.

Also, it is possible for the antenna device 21 to communicate with the antenna device 100 even when the antenna device 21 is placed at any position on the surface 111A of the plate 111.

Also, the antenna device 100 uses one antenna 120, and thus it is possible to reduce power consumption compared with the related-art millimeter wave antenna including a plurality of millimeter wave antenna elements.

Accordingly, with the embodiment, it is possible to provide the antenna device 100 that achieves reduction of power consumption while expanding a communication possible area in a planar manner using a radio wave having a millimeter wave band.

In this regard, in the above, a description has been given of the case where the plate 112 protrudes from the center of the plate 111 in the X-axis direction toward the negative direction side of the Z-axis. However, the position to which the plate 112 protrudes from the plate 111 may be shifted from the center of the plate 111 in the X-axis direction. The position that is shifted from the center of the plate 111 in the X-axis direction may be at any position between the end part in the negative X-axis side of the plate 111 and the end part of the positive X-axis side.

Also, in the above, a description has been given of the configuration in which the length of the plate 112 in the Y-axis direction is equal to the length of the plate 111 in the Y-axis direction. However, the length of the plate 112 in the Y-axis direction may be shorter than the length of the plate 111 in the Y-axis direction. The length of the plate 112 in the Y-axis direction may be equal to the length (the thickness of the plate 112) of the plate 112 in the X-axis direction.

In this case, the positional relationship between the plate 112 and the antenna 120 may be set such that the antenna 120 falls in the X-axis direction width of the plate 112 in the X-axis direction, and in the Y-axis direction width of plate 112 in the Y-axis direction.

Also, in the above, a description has been given of the configuration in which the antenna device 100 is disposed on the housing 13 such that the radiation surface 101 is exposed from the opening 13B of the surface 13A of the housing 13. However, the radiation surface 101 may be covered with the housing 13, another thin film, or the like.

Also, in the above, a description has been given of the case where a patch antenna is used for the antenna 120. However, a dipole antenna or slot antenna may be used in place of the antenna 120 formed by the patch antenna.

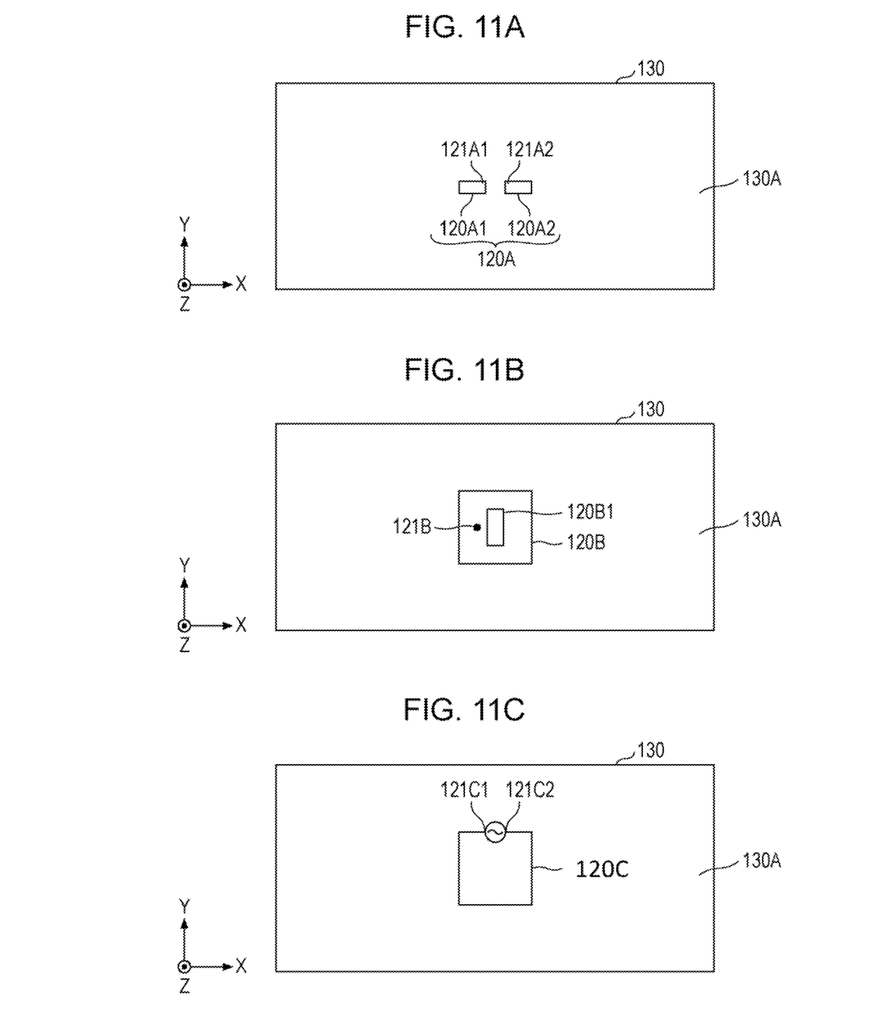

FIGS. 11A, 11B, and 11C are diagrams illustrating a dipole antenna, a slot antenna, and a loop antenna, respectively.

A dipole antenna 120A illustrated in FIG. 11A may be used in place of the antenna 120 formed by the patch antenna. The dipole antenna 120A includes antenna elements 120A1 and 120A2. The antenna elements 120A1 and 120A2 extend along the X-axis, and are supplied with power at center-side feed point 121A1 and 121A2, respectively. It is also possible to radiate a millimeter wave having the electric field that changes in the X-axis in the positive direction of the Z-axis using the dipole antenna 120A like this.

In this regard, when the dipole antenna 120A is used, the positional relationship between the plate 112 and the dipole antenna 120A is set preferably such that the dipole antenna 120A falls in the width of the plate 112 in the X-axis direction and the width of the plate 112 in the Y-axis.

Also, a ground plane may be disposed, to form a monopole antenna, in place of either one of the antenna elements 120A1 and 120A2.

Also, a slot antenna 120B illustrated in FIG. 11B may be used in place of the antenna 120 formed by the patch antenna. The slot antenna 120B is produced by forming a slot 120B1 on the rectangular metal layer in the XY plane view. The slot 120B1 is a long and narrow rectangular opening in the Y-axis direction, and is disposed in the center of the rectangular metal layer. When the slot antenna 120B like this is provided with a feed point 121B on the negative direction side of the X-axis of the slot 120B1 to be supplied with power, it is possible to radiate a millimeter wave having the electric field that changes in the X-axis direction in the positive direction of the Z-axis. In this regard, the feed point 121B may be disposed on the positive direction side of the X-axis of the slot 120B1.

Also, when the slot antenna 120B is used, the positional relationship between the plate 112 and the slot antenna 120B is set preferably such that the slot 120B1 falls in the width in the X-axis direction of the plate 112 in the X-axis direction, and in the width in the Y-axis direction of the plate 112 in the Y-axis direction.

Also, a loop antenna 120C illustrated in FIG. 11C may be used in place of the antenna 120 formed by the patch antenna. The loop antenna 120C is an antenna that includes a rectangular loop, and is supplied with power between the feed points 121C1 and 121C2. It is possible to radiate a millimeter wave having an electric field that changed in the X-axis direction in the positive direction of the Z-axis using the loop antenna 120C like this.

In this regard, when the loop antenna 120C is used, the positional relationship between the plate 112 and the loop antenna 120C is set preferably such that the loop antenna 120C falls in the width in the X-axis direction of the plate 112 in the X-axis direction, and in the width in the Y-axis direction of the plate 112 in the Y-axis direction.

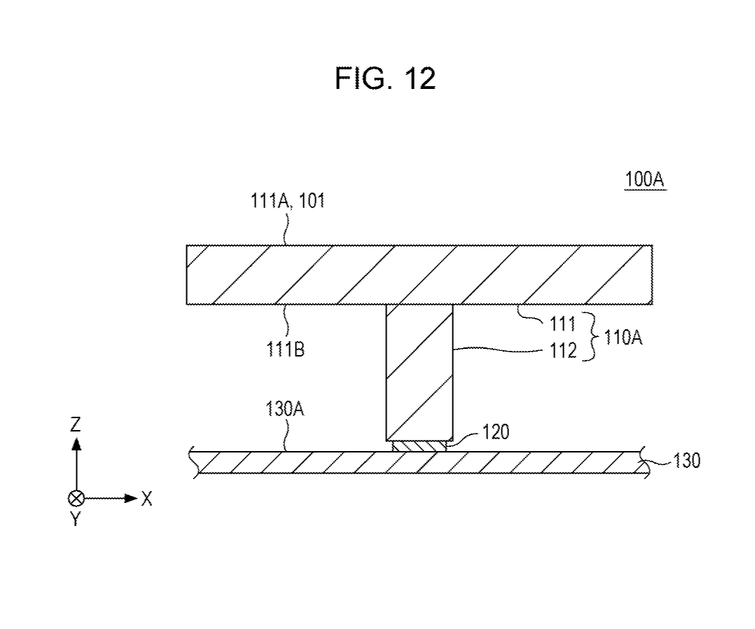

Also, in the above, a description has been given of the case where the plate 111 and the plate 112 of the radiation plate 110 are integrally formed. However, as illustrated in FIG. 12, the plate 111 and the plate 112 may be separate members.

FIG. 12 is a cross-sectional view illustrating an antenna device 100A according to a first variation of the first embodiment. FIG. 12 is the cross-sectional view corresponding to FIG. 3.

The antenna device 100A includes a radiation plate 110A, an antenna 120, and a substrate 130.

The radiation plate 110A includes the plates 111 and 112, and has a T-shaped configuration as viewed from the Y-axis direction. The plates 111 and 112 of the radiation plate 110A are separate members, and the plate 112 is joined with the surface 111B of the plate 111.

The antenna device 100A is the same as the antenna device 100 illustrated in FIG. 2 to FIG. 5 except that the plate 111 and the plate 112 are separate members.

In this manner, the radiation plate 110A may be formed by joining the plate 111 and the plate 112, which are separate members.

Also, in the above, the radiation plate 110 is a separate member of the housing 13 of the electronic apparatus 10 (refer to FIG. 1). However, the radiation plate 110 and the housing 13 may be integrally formed.

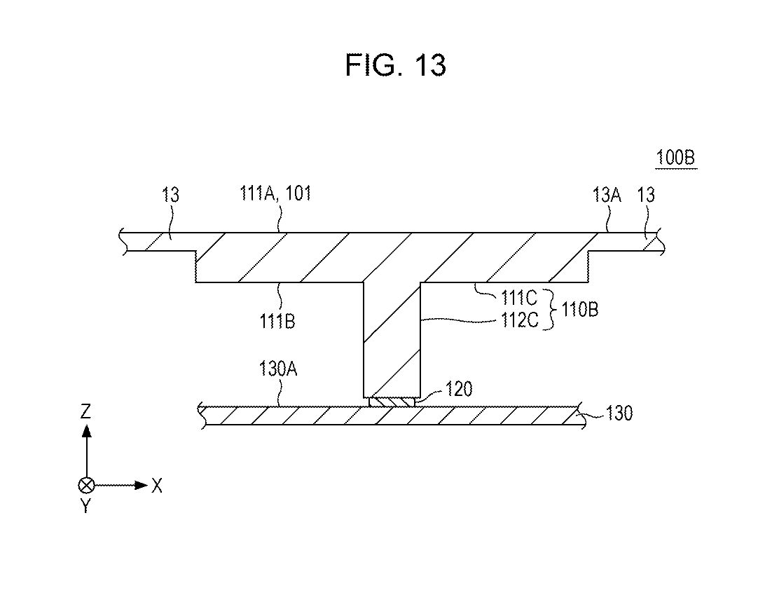

FIG. 13 is a cross-sectional view illustrating an antenna device 100B according to a second variation of the first embodiment. FIG. 13 is the cross-sectional view corresponding to FIG. 3.

The antenna device 100B includes a radiation plate 110B, an antenna 120, and a substrate 130. The radiation plate 110B includes plates 111C and 112C, and has a T-shaped configuration as viewed from the Y-axis direction.

The plates 111C and 112C are formed integrally with the housing 13. The plates 111C and 112C are made of the same dielectric material as that of the housing 13.

The plate 111C indicates a thicker potion which protrudes toward the back side opposite to the surface 13A of the housing 13, and is provided with the plate 112C on the negative direction side of the Z-axis. The sizes of the plates 111C and 112C are equal to those of the plates 111 and 112 illustrated in FIG. 3, respectively.

A millimeter wave propagated inside the plate 112C in the Z-axis direction is propagated inside the plate 111C in a direction parallel to the XY plane. This is the same as the plates 111 and 112 illustrated in FIG. 3.

The thicknesses of the plate 111C and the housing 13 are set such that a millimeter wave propagated, in the XY plane view, in the plate 111C toward the boundary between the plate 111C and the housing 13 is reflected by the boundary between the plate 111C and the housing 13.

The thinner the dielectric, the higher the transmission loss of the electromagnetic wave, and thus the millimeter wave hardly invades the inside of the wall part of the housing 13 from the end part of the plate 111C.

Accordingly, the millimeter wave is reflected by the end portions of the plate 111C in the same manner as the plate 111 illustrated in FIG. 3. The thicknesses of the plate 111C and the housing 13 are different by about three times, for example. The plate 111C is set preferably as thick as having a small loss so as to function as a waveguide, and thus have preferably the same thickness as that of the plate 112C. On the other hand, the housing 13 has preferably a thickness smaller than the thickness for functioning as a waveguide.

In this manner, with the antenna device 100B including the radiation plate 110B built by the plates 111C and 112C integrally formed with the housing 13, it is possible to reduce power consumption using a radio wave of the millimeter wave band while expanding the communication possible area in a planar manner.

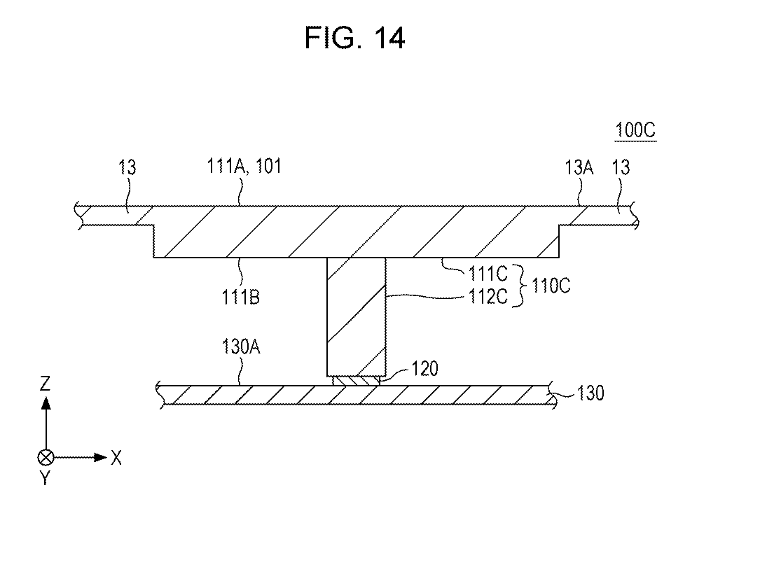

FIG. 14 is a cross-sectional view illustrating an antenna device 100C according to a third variation of the first embodiment. FIG. 14 is the cross-sectional view corresponding to FIG. 3.

The antenna device 100C includes a radiation plate 110C, an antenna 120, and a substrate 130. The radiation plate 110C is formed by the configuration in which the plates 111C and 112C illustrated in FIG. 13 are separate members. The plate 112C is joined with the surface 111B of the plate 111C.

The antenna device 100C is the same as the antenna device 100B illustrated in FIG. 13 except that the plates 111C and 112C are separate members.

In this manner, the radiation plate 110C may be configured by joining the plates 111C and 112C as separate members.

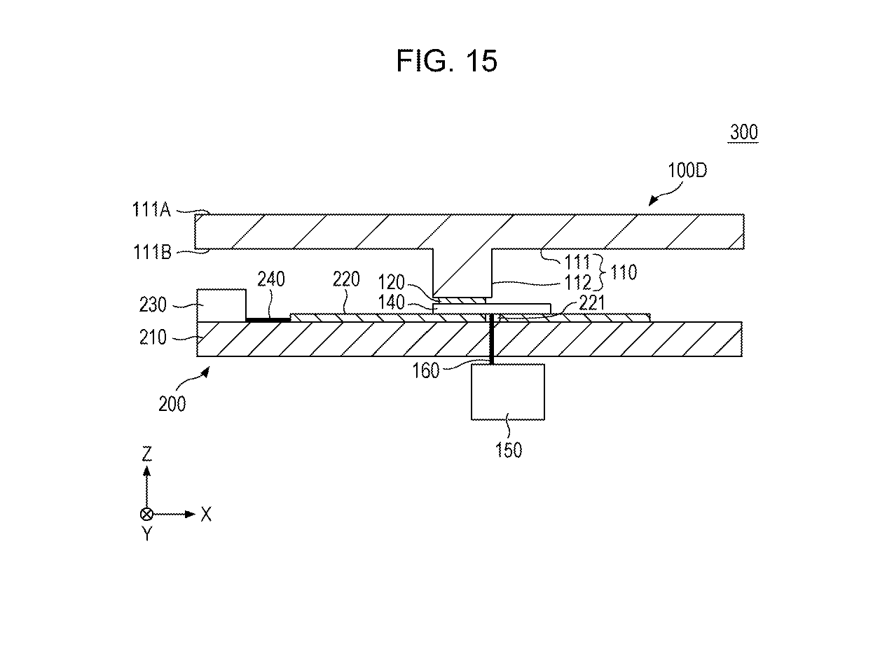

FIG. 15 is a cross-sectional view illustrating a communication module 300 including an antenna device 100D according to a fourth variation of the first embodiment. FIG. 15 is the cross-sectional view corresponding to FIG. 3.

The communication module 300 includes an antenna device 100D, a millimeter wave module 140, a signal processing unit 150, and an antenna device 200.

The antenna device 100D includes a radiation plate 110 and an antenna 120. The antenna device 100D includes a configuration in which the substrate 130 is removed from the antenna device 100 illustrated in FIG. 2 to FIG. 5. The antenna 120 of the antenna device 100D is disposed on the millimeter wave module 140.

The millimeter wave module 140 converts a signal input from the signal processing unit 150 through a via 160 into a millimeter wave, and outputs the millimeter wave to the antenna 120.

The signal processing unit 150 is disposed on the negative direction side of the Z-axis of the antenna device 200, and is connected to the millimeter wave module 140 through the via 160. The signal processing unit 150 includes a power supply unit that supplies power to the antenna 120. The signal processing unit 150 supplies power to the antenna 120 through the via 160 and performs baseband processing.

The via 160 passes through a through hole (via hole) of the substrate 210 of the antenna device 200 and the inside a cavity 221 that is disposed on the antenna 220 of the antenna device 200, and electrically connects the millimeter wave module 140 and the signal processing unit 150. The power and the signal that are output from the signal processing unit 150 are transmitted to the millimeter wave module 140 through the via 160.

Also, the signal received by the antenna 120 is transmitted from the millimeter wave module 140 to the signal processing unit 150 through the via 160.

The antenna device 200 includes a substrate 210, an antenna 220, a communication module 230, and a wiring line 240. The antenna device 200 is an example of the second antenna device.

The antenna device 200 is a communication device that performs near field communication by a band less than 6 GHz, for example. The substrate 210 is an FR4 standard substrate, for example, and is provided with the antenna 220 on the surface on the positive direction side of the Z-axis. As an example, the substrate 210 has the same size as the plate 111 in the XY plane view. In this regard, the size of the substrate 210 in the XY plane view may be different from the size of the plate 111.

The antenna 220 is a rectangular patch antenna in the XY plane view, for example, and the size of the patch is set in accordance with communication by a predetermined frequency band less than 6 GHz. The antenna 220 is supplied with power by the communication module 230 through the wiring line 240.

Also, the antenna 220 includes the cavity 221, and the via 160 is inserted into the inside of the cavity 221.

In this regard, the antenna 220 is not limited to a patch antenna, and may be a loop antenna that forms a loop in the XY plane, for example. A loop antenna including a loop having a size in accordance with the communication by a predetermined frequency band less than 6 GHz may be used as the antenna 220. In this case, the millimeter wave module 140 is preferably disposed in the loop of the antenna 220 in the XY plane view.

The antenna device 100D is piled with the antenna device 200 that performs communication by a band less than 6 GHz in the Z-axis direction to form the communication module 300.

Accordingly, it is possible to perform near field communication using a millimeter wave that the plate 111 radiates or receives using the communication module 300, and to perform near field communication using a radio wave having the band of less than 6 GHz that the antenna 220 radiates or receives.

In the above, descriptions have been given of the antenna devices according to the exemplary embodiments of the present disclosure and communication module. However, the present disclosure is not limited to the specifically disclosed embodiments, and various variations and changes are possible without departing from the scope of the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device comprising:
a first dielectric having a plate-like shape that has a first surface and a second surface, the first surface opposing the second surface;
a second dielectric having a plate-like shape, the second dielectric rising from the second surface, the second dielectric forming a T-shaped configuration with the first dielectric, the second dielectric having a distal end opposing the second surface; and
an antenna arranged on the distal end, the antenna being configured to radiate a millimeter wave having an electric field changing in a thickness direction of the second dielectric,
wherein wireless communication is performed through the first surface.

2. The antenna device according to claim 1, wherein
the first dielectric is a plate-like member extending in a first axial direction and a second axial direction,
the second dielectric rises from an intermediate point of the first dielectric in the first axial direction and extends in the second axial direction, and
the first dielectric and the second dielectric form the T-shaped configuration as viewed from the second axial direction.

3. The antenna device according to claim 2, wherein
the second dielectric rises from a middle point of the first dielectric in the first axial direction.

4. The antenna device according to claim 2, wherein
lengths of the first dielectric and the second dielectric in the second axial direction are equal.

5. The antenna device according to claim 2, wherein
thicknesses of the first dielectric and the second dielectric are equal.

6. The antenna device according to claim 2, wherein
the first dielectric and the second dielectric are as thick as having a small loss when the first dielectric and the second dielectric function as a waveguide.

7. The antenna device according to claim 1, wherein
the first dielectric is a part of a housing of an electronic apparatus mounting the antenna device, and is thicker than surrounding parts of the first dielectric.

8. The antenna device according to claim 1, wherein
the first dielectric and the second dielectric are integrally formed.

9. The antenna device according to claim 1, wherein
the first dielectric and the second dielectric are separate members, and the second dielectric is joined with the second surface of the first dielectric.

10. The antenna device according to claim 2, wherein
the antenna is a dipole antenna including a first antenna element and a second antenna element, the first and second antenna elements being disposed along a thickness direction of the second dielectric.

11. The antenna device according to claim 2, wherein
the antenna is a monopole antenna including a ground plane and an antenna element extending from the ground plane along a thickness direction of the second dielectric.

12. The antenna device according to claim 2, wherein
the antenna is a patch antenna configured to be supplied with power supplied at one end in a thickness direction of the second dielectric.

13. The antenna device according to claim 2, wherein
the antenna is a slot antenna configured to be supplied with power supplied at one end in the thickness direction of the second dielectric.

14. A communication module comprising:
an antenna device including,
a first dielectric having a plate-like shape that has a first surface and a second surface, the first surface opposing the second surface, the first dielectric is a plate-like member extending in a first axial direction and a second axial direction,
a second dielectric having a plate-like shape, the second dielectric rising from the second surface, the second dielectric forming a T-shaped configuration, as viewed from the second axial direction, with the first dielectric, the second dielectric having a distal end opposing the second surface, the second dielectric rises from an intermediate point of the first dielectric in the first axial direction and extends in the second axial direction, and
an antenna arranged on the distal end, the antenna being configured to radiate a millimeter wave having an electric field changing in a thickness direction of the second dielectric,
wherein wireless communication is performed through the first surface; and
a second antenna device including a second antenna configured to radiate and receive an electric wave in a frequency band lower than the millimeter wave.
